(19) United States
(12) Patent Application Publication
(10) Pub. No.: US 2011/0027623 A1
(43) Pub. Date: Feb. 3, 2011

(54) Electrochemical device

(76) Inventor: John Michael David Coey, Dublin (IE)

Correspondence Address: JACOBSON HOLMAN PLLC, 400 SEVENTH STREET N.W., SUITE 600, WASHINGTON, DC, 20004, US

(21) Appl. No.: 12/656,244

(22) Filed: Jan. 21, 2010

Related U.S. Application Data
(60) Provisional application No. 61/202,018, filed on Jan. 21, 2009.

(51) Int. Cl. H01M 8/10; H01M 8/24

(52) U.S. Cl. 429/10

(57) ABSTRACT

An electrochemical device comprises a primary magnet and a secondary magnet for applying forces to magnetic entities of an electrolyte. The primary magnet is arranged to induce a magnetic moment in the magnetic entities and the secondary magnet being arranged to create a magnetic field gradient in the vicinity of the magnetic entities to control the magnetic entities. The electrochemical device may be a fuel cell such as alkaline fuel cell or a proton exchange membrane fuel cell.

### INTRODUCTION

The invention relates to an electrochemical device.

Most of the magnetic-field effects that have been observed in electrochemistry [1-3], including enhanced metal electrodeposition rates [4-6], modifications of the morphology of the deposit [7-9], shifts of the rest potential [10-13], changes of corrosion rate [14-16], variations of pH [17] and changes of reaction rate at microelectrodes [18,19] can be attributed to perturbation of the mass-transport limited currents by convection induced by the Lorentz force density in N m⁻³

F_{L}=j×B (1)

where j is the current density in A m⁻² and B is the magnetic field in tesla (T). This is frequently referred to as the magnetohydrodynamic (MHD) effect when the magnetically-induced convective flows are on the scale of the cell [20], and the micro-MHD effect when they are localized very close to the electrode surface [21].

There is also evidence that a magnetic field gradient can influence electrode reactions involving paramagnetic ions in solution [22-26]. Here the force density involved is

F _{V̅}=cχₘ V̅B²/2μ₀ (2)

where the electrolyte contains a concentration c mol m⁻³ of a species with molar susceptibility χₘ m³ mol⁻¹ and μ₀ is the magnetic constant 4π 10⁻⁷ T m A⁻¹. Equivalent units are T² m²J⁻¹. Enhancement of oxygen reaction rates have been reported by Kishioka et al [24] using a superconducting magnet, and by Okada et al [25] and Wakayama et al [26] using permanent magnets placed behind a Pt working electrode. The magnetic gradients V̅B² in these studies are 10²-10³ T² m⁻¹, and the forces are comparable to the Lorentz force. White et al have used the magnetic gradient to focus the flow of paramagnetic ions near the electrode [22, 23]. They have demonstrated that an iron microelectrode in a magnetic field will trap paramagnetic molecules in regions of space where the product of magnetic field and magnetic field gradient is largest [23].

A third force, the ‘paramagnetic concentration gradient force’ which was supposed to arise when a uniform magnetic field gradient acts on a concentration gradient of a magnetic species in solution, has recently been shown to have no physical reality. It is a consequence of using an erroneous expression for the magnetic free energy [27, 28]

There is a continuing need for improved electrochemical devices in which the electrochemical process is enhanced. One application for such electrochemical devices is in fuel cells.

### STATEMENTS OF INVENTION

According to the invention there is provided an electrochemical device comprising:—
a primary magnet and a secondary magnet for applying forces to magnetic entities of an electrolyte, the primary magnet being arranged to induce a magnetic moment in the magnetic entities; and
the secondary magnet being arranged to create a magnetic field gradient in the vicinity of the magnetic entities to control the magnetic entities.

In the invention, an electrochemical cell is provided in which reactions involving paramagnetic species in solution enhance or modify the rate of electrochemical reaction.

In one embodiment the product of the field B (in Tesla) and the field gradient V̅B (Tesla per metre) is from 10² to 10⁸ T²/m, preferably from 10⁴ to 10⁶ T²/m, most preferably approximately 10⁵ T²/m.

In one case the secondary magnet is incorporated in an electrode of the electrochemical device.

In one embodiment the electrode comprises a ferromagnetic material. The electrode may comprise a nanowire array. In one case the diameter of the nanowires in the nanowire array is in the range of from 10 nm to 10 μm. The diameter of the nanowires may be from 10 nm to 1 μm, typically approximately 100 nm.

In one embodiment the nanowire array comprises a porous template having a partial coating of an electrode material and a partial filling of a ferromagnetic material.

The porous template may comprise alumina.

The electrode material may be platinum.

In one embodiment the ferromagnetic material comprises cobalt or a ferromagnetic alloy based on cobalt or iron.

In one case the primary magnet is an electromagnet.

The primary magnet may be a permanent magnet structure external or internal to the electrochemical cell.

The primary magnet may comprise an arrangement of permanent magnet segments.

In one case the electrode is movable. The electrode may be rotatable.

The invention also provides an energy storage and/or generating system which based on an electrochemical device of the invention.

The invention further provides a fuel cell such as an alkaline fuel cell or a proton exchange membrane fuel cell based on an electrochemical device of the invention. Also provided is a fuel cell stack comprising a plurality of such fuel cells.

### BRIEF DESCRIPTION OF THE DRAWINGS

The invention will be more clearly understood from the following description of an embodiment thereof, given by way of example only, with reference to the accompanying drawings, in which:—

FIG. 1 is a diagram of an electrochemical device of the invention;

FIG. 2 is a diagram of another electrochemical device of the invention;

FIG. 3 is a diagram of a magnet array used in the device of FIG. 2;

FIG. 4 is a schematic representation of rotating disk electrodes (RDE's). δ is the thickness of diffusion layer and d is the length of the Co nanowires;

FIG. 5 shows polarisation curves of potential versus current for the reduction of oxygen in [A] as prepared and [B] Oxygenated 21 mM Na₂B₄O₇, 10H₂O+0.12 M H₃BO₃ solution of pH 8.4 on a rotating disc electrode ‘A’. Magnetic fields a) 0.0 T, b) 0.4 T and c) 1.0 T were applied and the rotation speeds were: 0, 500, 1000, 2000 and 3000 revolutions per minute (rpm). Scan rate is 5 mVs⁻¹;

FIG. 6 (a) Koutecky-Levich and (b) Levich plots of the limiting current against ω^{1/2} for oxygen reduction in O₂-saturated 21 mM Na₂B₄O₇, 10H₂O+0.12 M H₃BO₃ solution of pH 8.4 with electrode ‘A’ for different externally applied magnetic field (▪) 0.0 T, () 0.4 T and (∘) 1.0 T;

FIG. 7 shows polarisation curves for electrode ‘B’ in the same conditions as FIG. 5;

FIG. 8 shows polarisation curves for electrode ‘C’ in the same conditions as FIG. 5;

FIG. 9 shows chronoamperograms obtained for electrode ‘A’ in the as prepared [A] and Oxygenated [B] borate buffer electrolyte in (a) the absence of the application of an external magnetic field (0 T) and (b) with the application of external magnetic field 0.4 T and (c) with 1.0 T, for rotation speeds 0, 500, 1000, 2000 and 3000 rpm at a potential of −400 mV vs. Ag/AgCl the insets are Cottrell plots of the respective Current-time transients—note the different vertical scales;

FIG. 10 shows chronoamperograms obtained for electrode ‘B’ in the same conditions as in FIG. 9;

FIG. 11 shows chronoamperograms obtained for electrode ‘C’ in the same conditions as FIG. 9;

FIG. 12 is a plot of enhancement of oxygen reduction at −400 mV for air-saturated buffer (open points) in 0.4 T and 1.0 T and oxygen-saturated buffer (solid points) in 0.4 T and 1.0 T for electrodes ‘A’ and ‘C’. The upper 4 curves are for electrode ‘A’. The lower curves are for electrode ‘C’. Square points represent the current enhancement at 0.4 T while round points represent the current enhancement at 1.0 T;

FIG. 13 shows chronoamperometry for electrode ‘C’ in the air saturated acidic bath (0.5 M H₂SO₄) at 0 T and 1.5 T averaged over a number of runs;

FIG. 14 shows the mean current enhancement for electrode ‘C’;

FIG. 15 shows chronoamperometry for electrode ‘A’ in the air saturated acidic bath (0.5 M H₂SO₄) at 0 T and 1.5 T averaged over a number of runs;

FIG. 16 shows the mean current enhancement for electrode ‘A’ in the air saturated acidic bath between 0 T and 1.5 T;

FIG. 17 is a schematic diagram of an alkaline fuel cell [30]; and

FIG. 18 is a schematic diagram of a proton exchange membrane fuel cell [30].

### DETAILED DESCRIPTION

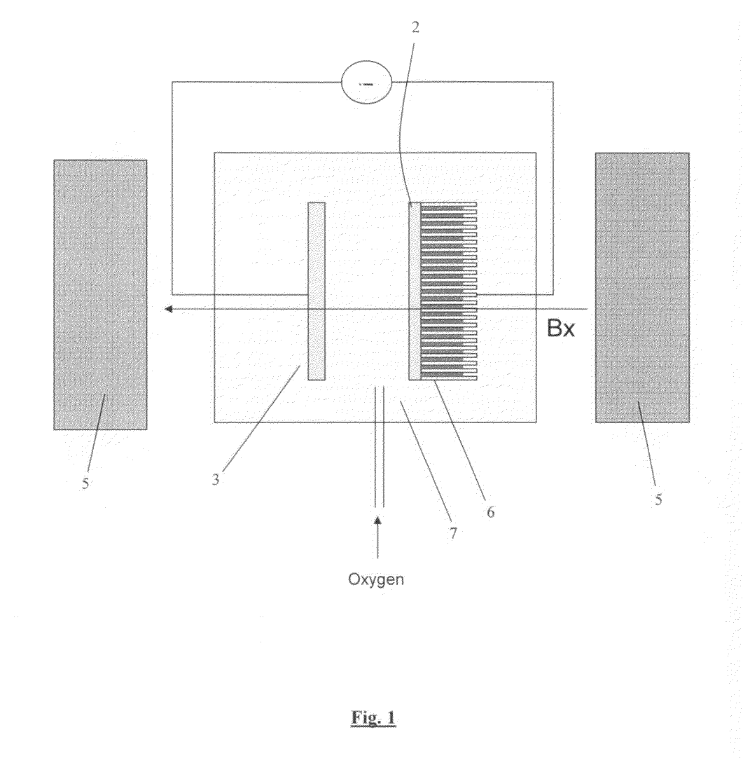

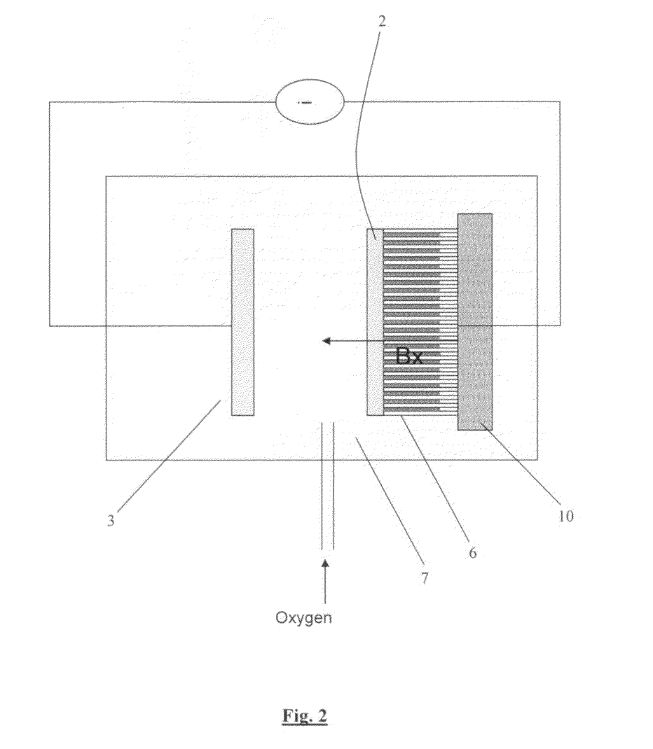

Referring to FIGS. 1 and 2 an electrochemical device 1 of the invention comprises a working electrode 2 and a counter electrode 3. The device 1 comprises a primary magnet 5 (designated X) and a secondary magnet 6 (designated Y) for applying forces to magnetic entities of an electrolyte 7. The primary magnet 5 is arranged to induce a magnetic moment in the magnetic entities. The secondary magnet 6 is arranged to create a strong magnetic field gradient in the vicinity of the magnetic entities.

The electrochemical device comprises a bipartite magnetic gradient structure, one or both parts of which are immersed in an electrolyte 7. The two parts are designated X and Y. X serves to create a magnetic field B_{X} across the electrochemical device. A magnetic field gradient B_{Y} is generated at the end of part Y near to the interface between the electrode 2 and the electrolyte 7. The B_{X} field may be uniform or non-uniform, and it serves to induce a magnetic moment m on entities immersed in the electrolyte. These entities may be paramagnetic atoms, ion or molecules with unpaired electron spins, small superparamagentic particles, or clusters of such particles or other small magnetically-ordered entities. Part Y is a ferromagnetic structure or array which is dimensioned on the scale 1 of the entities, or groups of entities which it is desired to protect from the effect of dispersion in the electrolyte.

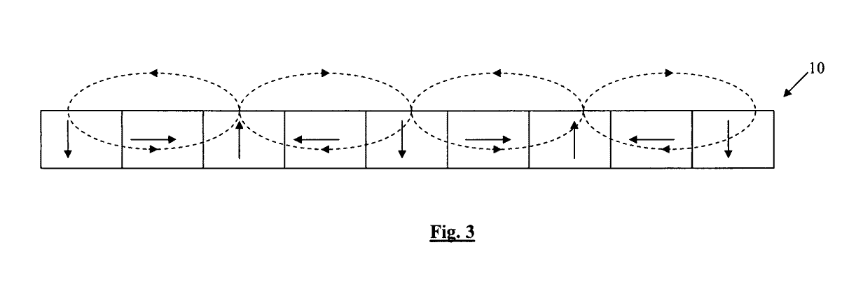

Referring especially to FIG. 1, in one embodiment, X can be an electromagnet or a permanent magnet 5 which produces a magnetic field which is approximately uniform in the scale 1. One way to create such a field is to use an array of magnets or magnetised elements whose size is much greater than 1, which are magnetised in different directions. FIG. 3 illustrates a segment of a one-sided magnet 10. The magnetic field is generated at the upper surface, as shown by the field lines. Referring to FIG. 2, such a one—sided magnet 10 may be incorporated into the electrochemical cell.

The field B_{X} may be variable or fixed. The field in an electromagnet is varied by changing the current in the windings, whereas that of the permanent magnet array is varied by alternating the position or orientation of some elements of the array with respect to that of others. These methods are known and described in textbooks such as Skomski and Coey, Permanent Magnetism, IOP Press, Bristol, 1999, Ch 5.

The external magnet 5 may comprise one or two poles. It is advantageous to place it as close to the working electrode as possible. Indeed, the magnet may be located inside the cell.

Y is a ferromagnetic structure, which is dimensioned or divided on a scale 1. It is immersed in electrolyte, or positioned at a distance of order 1 or less from the interface, where the entities are to be gathered. Y may be composed of one or many ferromagnetic wires, or segments. They may be permanently magnetised, or else they can be magnetised by the field created by X. The magnet array Y creates a spatially inhomogeneous magnetic field B_{Y} in the vicinity of the magnetic entities. The gradient V̅B_{Y} is important for the operation of the invention.

Many electrochemical processes involve paramagnetic ions or free radicals in solution in the electrolyte. Examples include molecular oxygen O₂ which is normally in a triplet state with spin S=1. It is involved in electrolysis of water and also at the oxygen electrode in fuel cells. By modifying the concentration of oxygen or related paramagnetic species it is possible to greatly enhance the currents flowing in the electrochemical cell and therefore the rate of production of the reaction product.

The electrochemical current associated with an oxygen reduction reaction can be greatly enhanced by the use of the bipartite magnetic structure. B, may be produced by an electromagnet. It is approximately uniform over the electrode surface. In the example B_{X} values of 0 T, 0.4 T and 1.0 T are compared.

Alternatively, Bₓ could be generated by a permanent magnet structure external to the electrochemical cell. Approximately uniform fields of up to about 1.5 T can be generated using Nd—Fe—B magnets and up to about 0.5 T when hexagonal ferrite magnets are used.

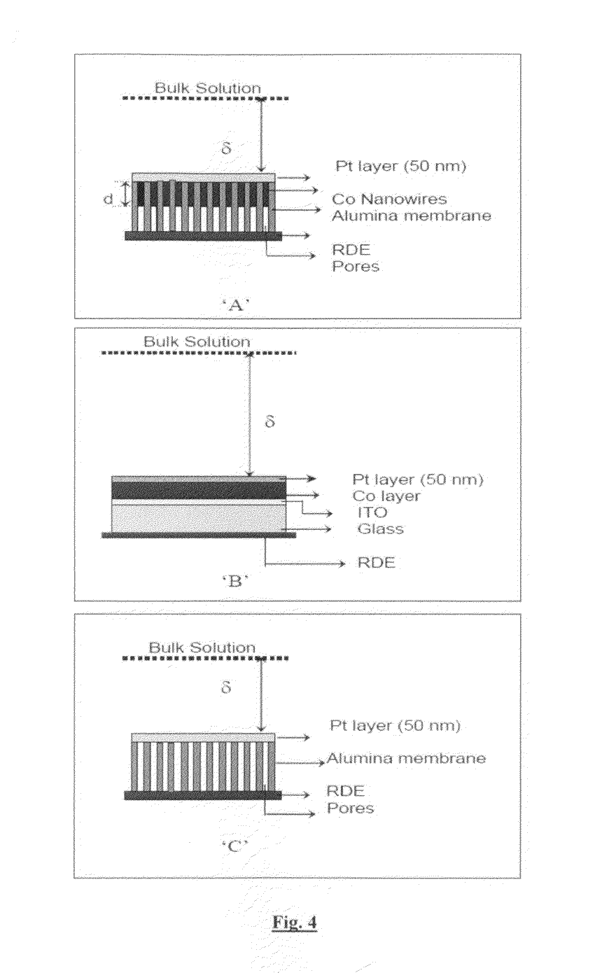

Alternatively, a non-uniform field, which varies on a scale L, much greater than the scale 1 on which the magnetic field B_{Y} varies, can be generated by an arrangement of permanent magnet segments such as the ‘one-sided’ magnet shown in FIG. 4B. Such magnet structures are known and used for example in sheets of bonded ferrite that adhere magnetically to a steel surface such as refrigerator magnets. The magnitude of the fields generated, are up to 0.4 T with sintered hexagonal ferrite and up to about 1.0 T with sintered NaFeB.

The advantage of using such a structure to generate B_{X} is that the magnet is compact and can be an incorporated aspect of the electrode itself, when L is of the order of 1-10 nm. The slow spatial variation does not impair the effectiveness of the bipartite structure.

The second part of the magnetic gradient structure in this example is a nanowire array obtained by electrodeposition of a ferromagnetic metal cobalt into a porous alumina template which was first coated on one side with the metal (platinum) that is to be used as the electrode ‘A’ in the electrochemical cell. Procedures for producing such nanowires in arrays are described in the literature (e.g. N. B. Chaure et al., Journal of Magnetism and Magnetic Materials 290 (2005) 1210).

In the example, a similar platinum plated alumina membrane which contains no ferromagnetic cobalt nanowires is used as a control. This is the electrode ‘C’.

Table 1 compares the electric current densities measured when electrode A and electrode C are used as cathodes in an electrochemical cell, where the electrolyte is oxygenated sodium borate at pH 8.4. (21 mM Na₂B₄O₇10H₂O+0.12M H₃BO₃) and the counter electrode is a platinum wire. The areas of the electrodes are 7×7 mm². The value of B_{X} is shown, and the electrodes are rotated at rates of up to 3000 rpm.

| | Bₓ/f | 0 T | 0.4 T | 1.0 T |
|---|---|---|---|---|
| Electrode A | 0 rpm | 6 | 10 | 13 |
| | 1000 rpm | 23 | 39 | 50 |
| | 3000 rpm | 36 | 68 | 80 |
| Electrode C | 0 rpm | 1.0 | 1.2 | 1.3 |
| | 1000 rpm | 6.5 | 6.8 | 7.0 |
| | 3000 rpm | 9.0 | 9.5 | 10.5 |

From the table it is seen that the current densities are greatly enhanced using electrode ‘A’, compared with electrode ‘C’ in the same conditions, by up to a factor of ten. The substantial enhancement is maintained when the electrode is rotating.

In this example the likely paramagnetic species in the electrolyte, the concentration of which is enhanced in the vicinity of the bipartite magnetic gradient electrode, are O₂ and HO₂⁻. A similar structure is applicable in an acid electrolyte of a fuel cell, where enhanced oxygen current densities can be obtained.

A similar structure can be used at the oxygen electrode in an electrochemical cell, used for electrolysis of water.

In these, and other cases involving paramagnetic ions, molecules or free radicals in the electrolyte, enhancements in current and efficiency can be obtained.

In more detail, the platinum-coated electrode (Electrode ‘A’) is designed to produce a magnetic field with V̅B² of at least 10² T² m⁻¹ and less than 10⁸ T² m⁻¹ at its surface in an applied field of 1 T. It is based on an array of cobalt nanowires embedded in an anodized alumina membrane. Performance for a series of electrochemical measurements on a model oxygen reduction reaction in an alkaline, and an acidic medium is compared with those of control electrodes with no cobalt (Electrode ‘C’), or with a continuous cobalt film behind the platinum surface (Electrode ‘B’). The measurements include rotating disk electrode cyclic voltammetry, steady state polarization and chronoamperometry. The limiting current for the field gradient electrode is enhanced by an order of magnitude compared to the controls, and the enhancement is retained when the electrode rotates. The effect is attributed to a concentration of paramagnetic species, HO₂⁻ and O₂, at the surface of the field gradient electrode. The results demonstrate the potential of using magnetic field gradient electrodes for electrochemical reactions involving paramagnetic species.

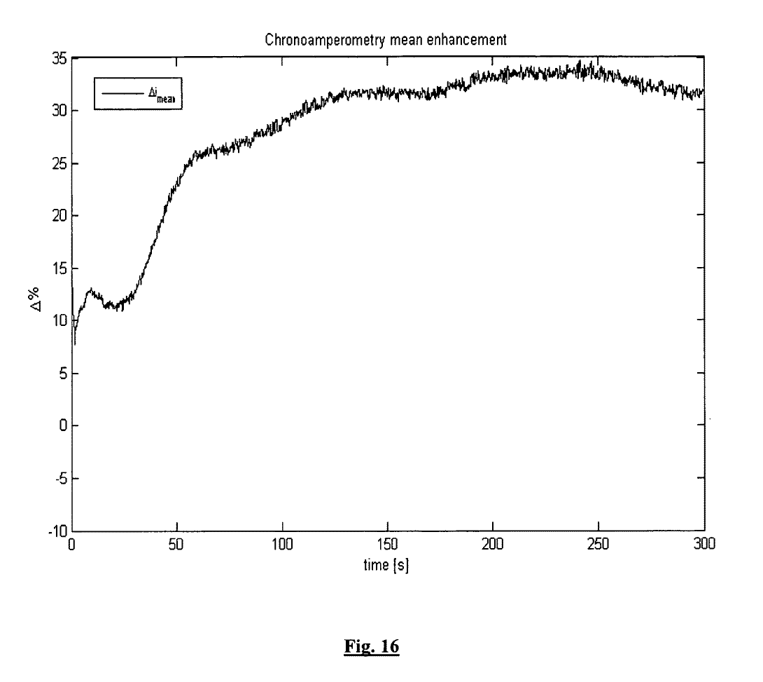

The invention is particularly applicable to fuel cells. A fuel cell is an electrochemical cell that generates electricity through the reaction of a fuel (on the anode side) and an oxidant (on the cathode side) [29]. This reaction is triggered by an electrolyte sandwiched between the cathode and anode. In effect, it is a battery in which reactants are fed into the cell, and the reaction products flow out of it. The two most relevant fuel cells are the Alkaline Fuel Cell (AFC), and the Proton Exchange Membrane Fuel Cell (PEMFC) [30-32]. In the case of alkaline fuel cells, the electrolyte contains KOH, and conducts Off ions from the cathode to the anode (see FIG. 17 [30]). The main advantages of AFCs include [30]:
Low operating temperature (65-220° C.) and pressure (1 bar)
High efficiency
Fast start time
No corrosion problems
Low weight and volume
Simple operation
Relatively low cost due to requiring only small amounts of expensive catalysts such as Pt.

However, their disadvantages include [30]:
Its use of a liquid electrolyte, which is difficult to handle
The need to evacuate the water treatment complex
Intolerance to CO₂ (up to 350 ppm) and some intolerance to CO, only pure electrolytic H₂ can be used as a fuel

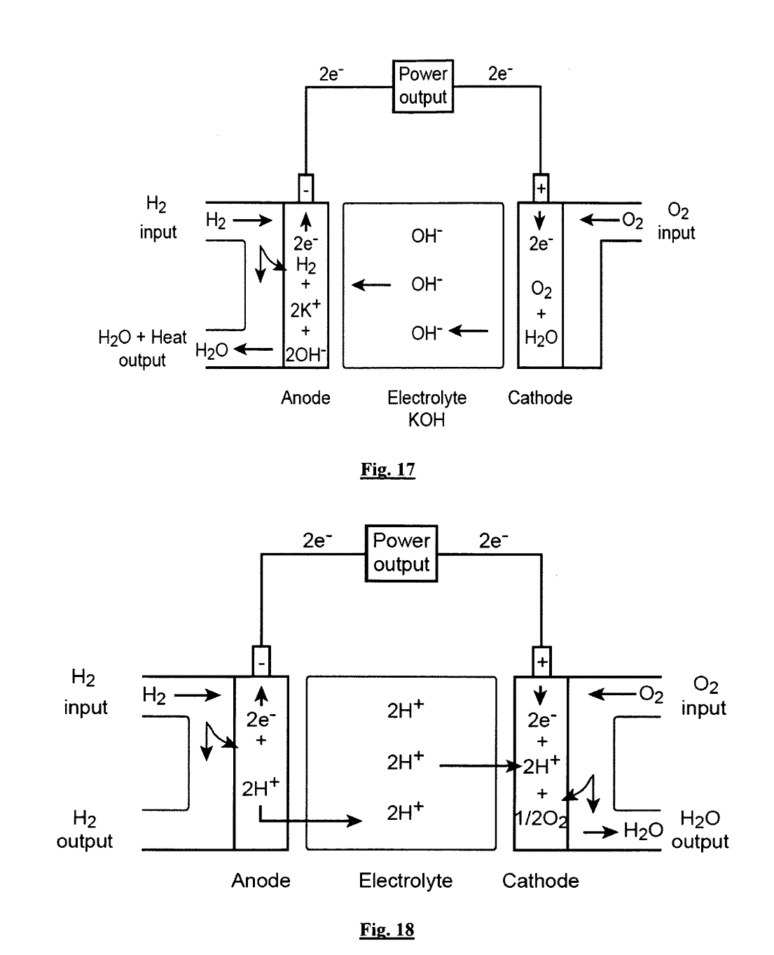

In contrast to AFCs, a polymer membrane that conducts H⁺ ions is used as the electrolyte in PEMFCs (see FIG. 18 [30]). The electrolyte normally consists of a perfluorosulphonic acid such as DuPonts Nafion polymer (a sulphonated tetrafluoroethylene based fluoropolymer-copolymer). The main advantages of PEMFCs include [30]:
Can operate at low temperatures (60-80° C.) and pressures (1-2 bar)
Simple to handle and assemble
Non-corrosive, dry, solid electrolyte
Tolerant of CO₂, atmospheric air can be used
Compact and robust
High power density

While their disadvantages include [30]:
Very sensitive to impurities of hydrogen
Intolerant to CO (>50 ppm), and Sulphur particles
Require humidification units for reacting gases. If water is used, the fuel cell must operate at temperatures below the boiling point of water, preventing the fuel cell from being a useful heat generator (cogenorator).
Expensive, requires a catalyst (Pt) and a membrane (solid polymer)
Electrode and membrane durability, dissolution of Pt and chemical/mechanical degradation of the membrane

PEMFC applications include transportation and automotive systems, building power generators, and replacement of rechargeable batteries in portable devices. To find widespread use, there are a number of technological barriers to overcome. These include lower cost of production, higher tolerance to CO impurities at the anode, and increased catalytic oxygen reduction currents.

The invention will be more clearly understood from the following examples.

### EXAMPLES

### Experimental Methods

The electrochemical measurements were conducted using an EG&G Princeton

Applied Research Potentiostat/Galvanostat (Model 263A) at a temperature of 25° C. Rotating disk data were collected using a Tachyprocessor instrument rotating at angular velocities of 0-3000 rpm (314 cs⁻¹). Cyclic voltammetry experiments were initially conducted at a sweep rate of 100 mV s⁻¹ to characterise the surface processes on the working electrode. Steady-state polarization at 5 mV s⁻¹ and chronoamperometry for times up to 50 s were used to determine the steady-state oxygen reduction currents.

Two electrolytes were considered, the first was an alkaline bath of 21 mM Na₂B₄O₇10H₂O and 0.12 M H₃BO₃ with a of pH 8.4; the second was an acidic bath of 0.5 M H₂SO₄ with a pH of 0.51. These were used to simulate conditions similar to those found in an Alkaline Fuel Cell (AFC), and a Proton Exchange Membrane Fuel Cell (PEMFC). Both were used as-prepared or in oxygenated form for all the electrochemical measurements. For the oxygenated bath, an oxygen flow was maintained during the electrochemical experiments.

Three different working electrodes were prepared. The field gradient electrode ‘A’ was prepared by first sputtering a 50 nm layer of Pt on one side of a commercial alumina membrane (Whatman) with pores 200 nm in diameter, having a centre separation of 250 nm. Cobalt nanowires 5 μm in length were then plated into the pores from an electrolytic bath consisting of 0.9M CoSO₄7H₂O, 0.11 M NaCl and H₃BO₃. The boric acid was used to adjust the pH of the bath between 2.5 and 3.5. Details are given elsewhere [34]. The same bath was used to deposit Electrode ‘B’, a uniform cobalt film of thickness 5 μm on indium tin oxide (ITO) coated conducting glass which was then coated with 50 nm of Pt. Electrode ‘C’ was the same as electrode ‘A’ but without the cobalt filling. In each case, the working surface which is exposed to the electrolyte is a thin layer of platinum. A schematic diagram of the three working electrodes is given in FIG. 4. Electrode areas are 50 mm². A Pt plate or mesh was used as the counter electrode, and the Ag/AgCl reference electrode was used with a modified luggin capillary. All three electrodes (‘A’, ‘B’ and ‘C’) were used for the measurements, with and without a uniform magnetic field of 0.4 T or 1.0 T applied parallel to the nanowires. The field was produced by a large electromagnet with 200 mm pole faces. Measurements were made with static and rotating electrodes at rates up to 3000 rpm.

### Example 1

### Steady state polarization

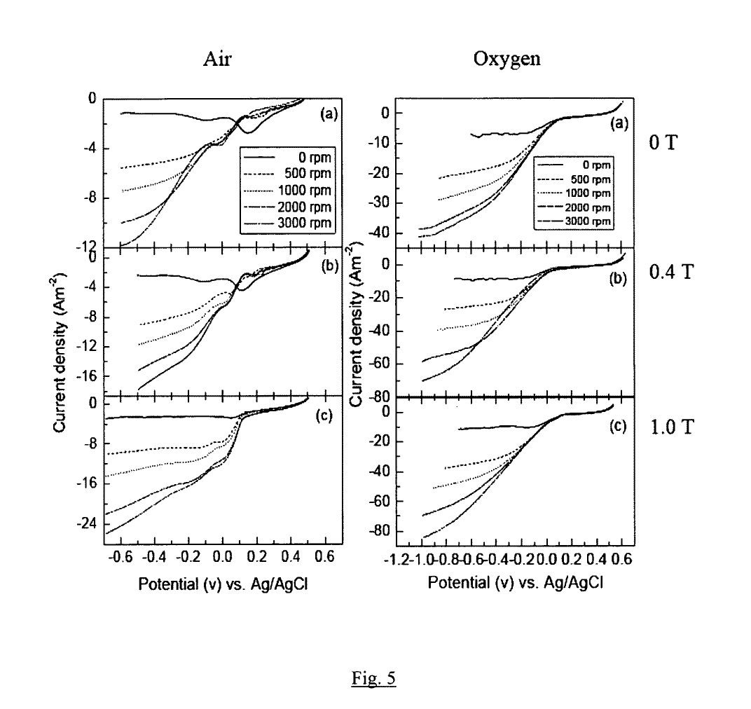

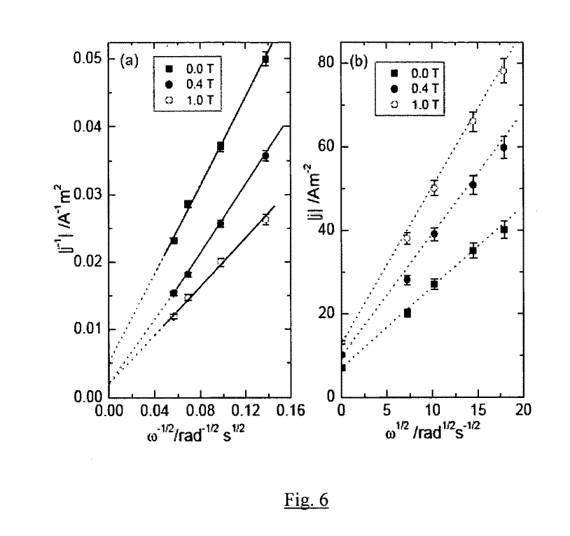

The steady state polarization experiments were carried out with all three electrodes in air-saturated and oxygenated borate buffer solution. The potential was swept towards the cathodic side to avoid the oxidation of platinum during anodic sweep and hence the kinetic complications resulting from slow reduction of platinum oxide. FIG. 5 shows the polarization curves for electrode ‘A’ obtained by sweeping the potential at 5 mV s⁻¹ with different rotation speeds. Three different regions are observed (1) a kinetic region due to charge transfer (˜500 mV to ˜100 mV where the current hardly depends on the rotation rate. (2) a region (˜100 mV to ˜−400 mV) where the current is controlled by both kinetic as well as diffusion processes. (3) A third region (−400 to −900 mV) where the current increases with rotation rate but changes very little with voltage. This is the mass transfer region. The effects of applied fields of 0, 0.4 and 1.0 T was measured at each rotation rate. A convection and diffusion limited current plateau is obtained in all polarization curves due to the oxygen transport from bulk of the electrolyte to the electrode surface being constant. The mass-transfer limited current enhancement for applied fields of 0.4 T and 1.0 T are summarized in Table 1. The magnitudes of the diffusion-limited currents suggest that the oxygenated solutions are not fully-saturated. Current enhancement is defined as

Percentage current enhancement={[J_{S}(B)−J_{S}(0)]/J_{S}(0)}×100% (3)

The enhancement is substantial, of order 100% in 1 T regardless of rotation rate. The mass transfer limiting current, I_{Lev}, arising from the convective-diffusive flux induced by the rotating disc electrode has a square root dependence on the rotation frequency, ω as given by the Levich equation, which should apply whenever mass-transfer processes in the solution solely control the oxygen reduction at the surface of the electrode:

I_{Lev}=(0.620)nFAD^{2/3}ω^{1/2}v^{-1/6}cₒ, (4)

where v is the kinematic viscosity of the aqueous solution, A is the electrode area and n, D and cₒ are the number of electrons transferred, the diffusion coefficient and the concentration of electroactive species respectively. The angular velocity ω=(2π/60)f, where f is the frequency of rotation rate in rpm.

A linear Levich plot, I_{Lev} versus ω^{1/2} passing through the origin, implies that the electrocatalytic reaction is faster than the rate of delivery of reagent to the electrode, so that the current is determined only by mass transport to the electrode surface. The plot of I_{Lev} versus ω^{1/2} will be linear, and from the slope, the value of the diffusion coefficient D can be obtained, using n=4, F=96,485 coulomb mol⁻¹, and taking c₀=0.25 mol m⁻³ in as-prepared solution and c₀=1.25 mol m⁻³ in a well-oxygenated solution [35]. The kinematic viscosity of the dilute borate solution used here is very close to that of water and thus may be taken as v=0.01 cm²s^{-1 [}36]. By means of the slope of Levich plots the diffusion coefficient was determined as 2.2×10⁻⁵ cm⁻¹ s⁻¹ for as prepared, and 2.4×10⁻⁵ cm⁻¹s⁻¹ for the oxygenated bath.

When the mass-transfer process in the solution and catalytic reaction become comparable in magnitude, the Koutecky-Levich equation may be used for kinetic analysis

$$\frac{1}{{I}_{lim}} = \frac{1}{{I}_{Lev}} + \frac{1}{{I}_{kin}} \qquad ( 5 )$$

Iₖᵢₙ, the kinetically controlled current is given by [57]

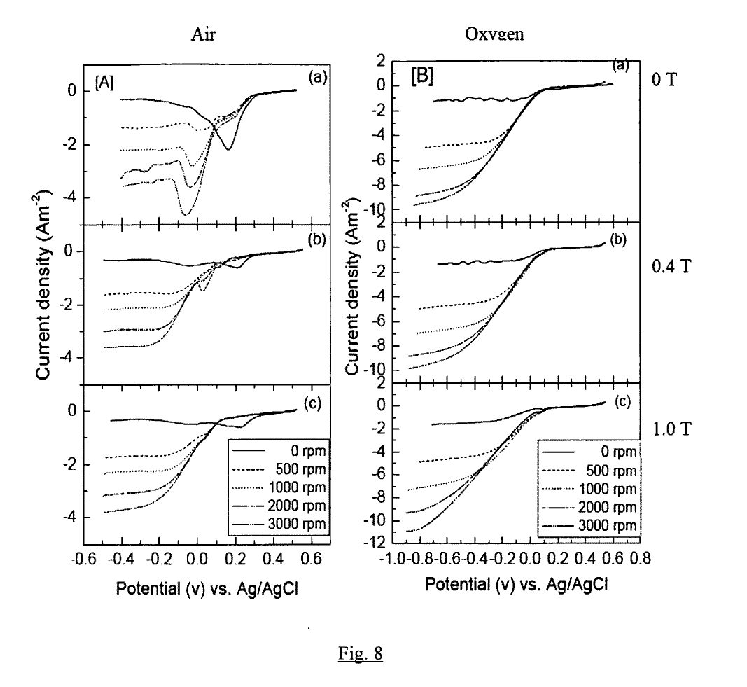

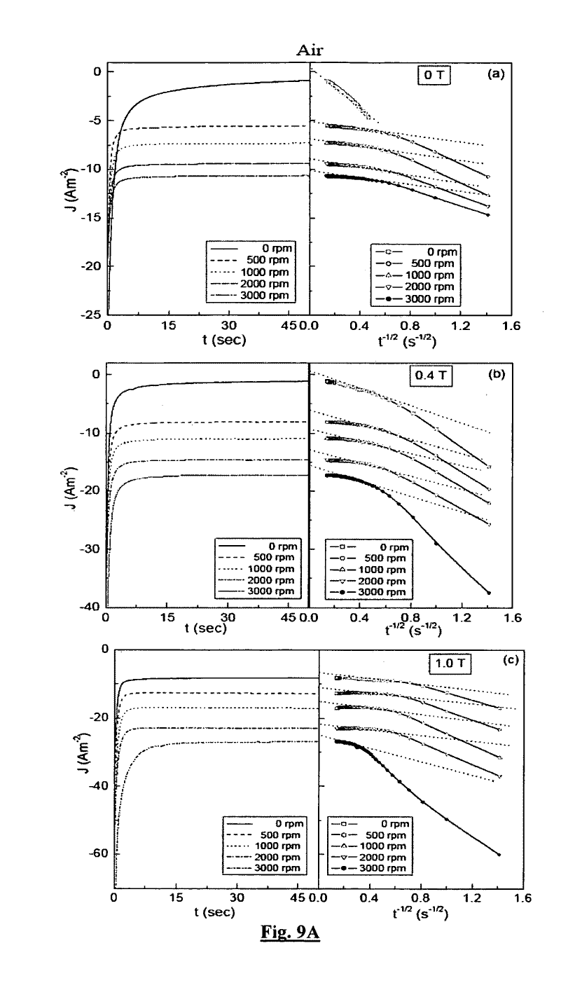

Iₖᵢₙ=nFΓAkc₀ (6)

where Γ is the surface coverage of the electrode and k is the rate constant for the reaction between the reactants in the solution and the electrode. The other symbols have their usual meaning. A plot of limiting current Iₗᵢₘ as a function of ω^{-1/2} yields a straight line whose intercept gives the value of k. Representative Koutecky and Koutecky-Levich plots, based on the oxygenated data of FIG. 5 are shown in FIG. 8. From the slope and intercept of the Koutecky-Levich the diffusion constant was determined to be 3.5 10⁻⁹ m² s⁻¹ and the rate constant was evaluated to be 1.5 10⁻³ m s⁻¹. It increases with applied field.

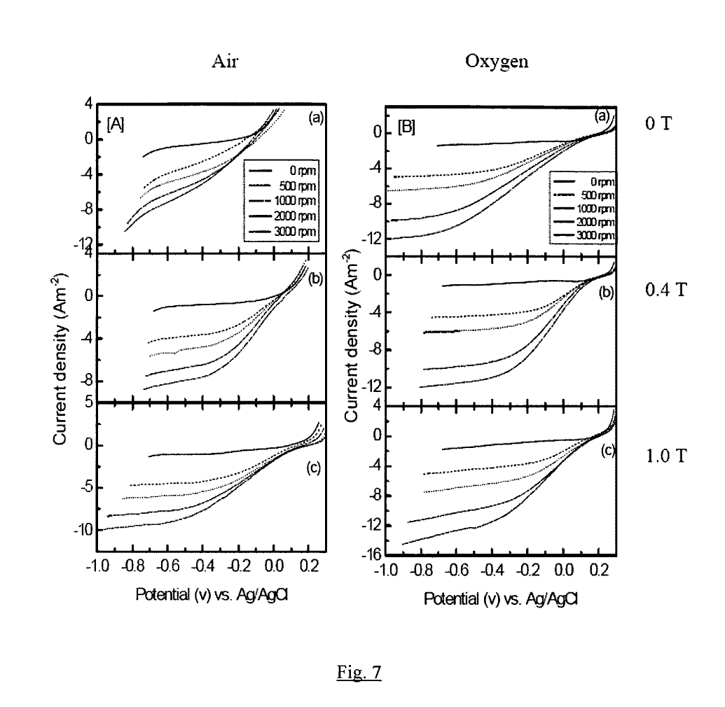

Similar sets of polarization experiments were carried out with electrode ‘B’ (FIG. 7) and electrode ‘C’ (FIG. 8).

In summary, the electrochemical response of the electrodes is similar. The main difference is the current density. The extent of the magnetic enhancement is best appreciated by comparing data in Table 1 on electrode ‘C’ in zero field with that on electrode ‘A’ in a 1 T field. When this comparison is made, the effect of the cobalt nanowires behind the platinum electrode is seen to increase the oxygen reduction current by approximately an order of magnitude, for either bath. These are large effects.

### Example 2

### Chronoamperometry

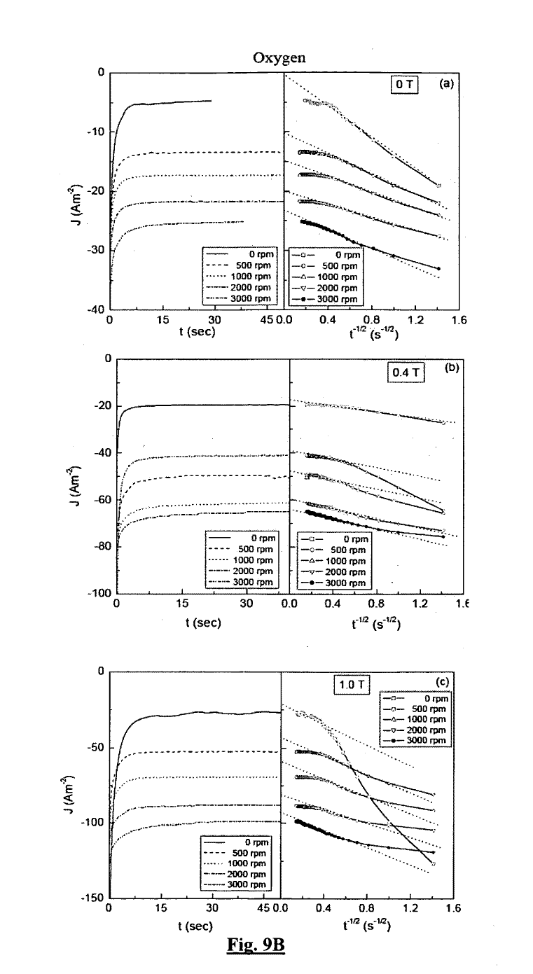

A similar set of measurements were made for all three electrodes using chronoamperometry. For the alkaline bath these experiments were carried out at a potential −400 mV versus Ag/AgCl, and at −250 mV versus Ag/AgCl for the acidic bath. In both cases this is where oxygen reduction occurs. Data with electrode ‘A’ for air-saturated and oxygenated borate buffer in absence and presence of externally applied magnetic field are depicted in FIG. 9 for the alkaline bath. The corresponding Cottrell plots of current density (A/m²) versus t^{-1/2} (s^{-1/2}) are shown in insets. After a sufficient time a steady-state limiting current is measured. In case of electrode ‘A’ this current is attained after 4 to 5 seconds. The initial part of each curve is a current transient due to the charging of the electrochemical double layer. The current enhancement for air-saturated solution is 47% and 135% in a 0.4 T and 1.0 T magnetic field respectively. The values of the net percentage current enhancement are determined by averaging the percentage current enhancement obtained for the rotation rates, 500, 1000, 2000 and 3000 rpm since any rotation rate greater than zero seems to have the same effect. They appear in brackets in Tables 1 and 2. The current densities and percentage current enhancement in chronoamperometric experiments are summarized in Table 2. In the case of oxygenated borate buffer, 189% and 297% average current enhancements were observed.

The current for the electrochemical reaction under mass transport control of an electroactive material (O₂) with a diffusion coefficient, D is described by the Cottrell equation:

$$J = \frac{{nFD}^{1 / 2} {c}_{0}}{{π}^{1 / 2} {t}^{1 / 2}} \qquad ( 7 )$$

where t is time. The average diffusion coefficients obtained in air-saturated and oxygenated solutions in zero field were found to be 1.92 10⁻⁹ m²s⁻¹ and 2.20 10⁻⁹ m²s⁻¹.

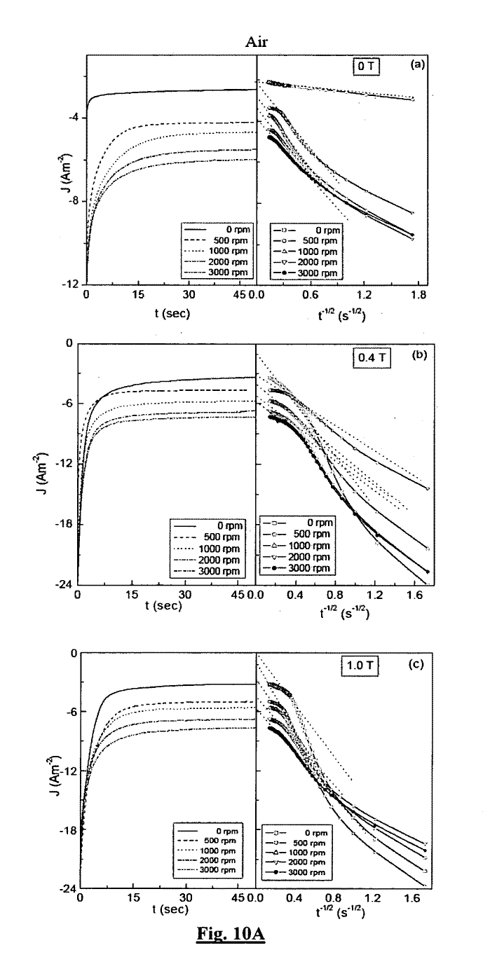

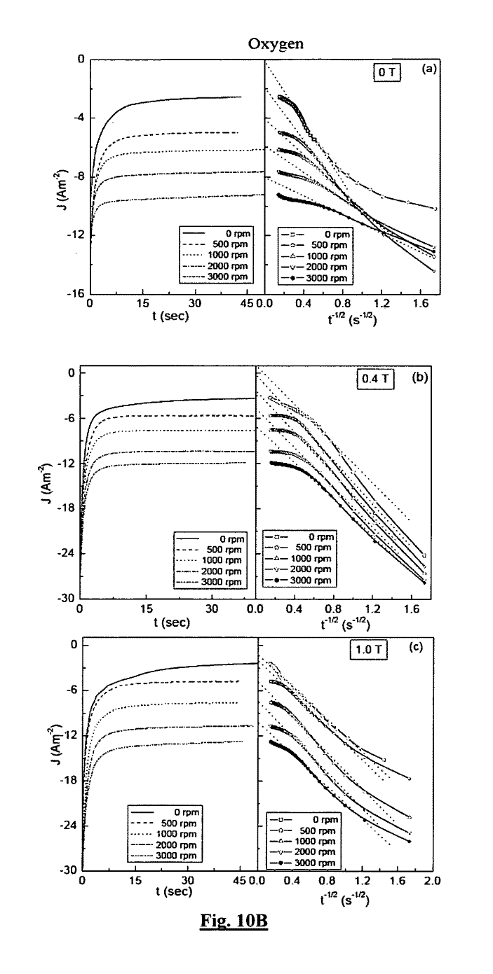

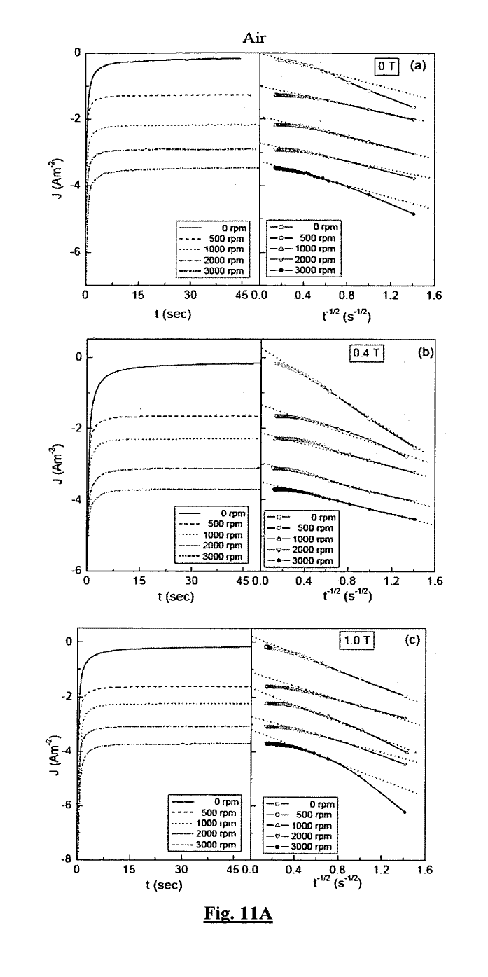

Similar chronoamperometric results for electrode ‘B’ and ‘C’ are shown in FIGS. 10 and 11. The data for electrode ‘C’ show that the average current enhancement here due to magnetic field is practically negligible, 4-9%.

Three significant observations stand out from these data.
i) The effect of the Lorentz force is negligible in stirred solution
ii) The magnetic gradient force is significant, even in stirred solutions
iii) The BOB product is critical for effective electrode design.

The enhancement of the limiting current for the oxygen reduction reaction, which is achieved with the magnetic field gradient electrode, is remarkable. The average current enhancement achieved with electrode ‘A’ in 1 T is 118% in the polarization experiments (Table 1) and 297% in chronoamperometry (Table 2), which provides a clearer idea of the steady-state response.

TABLE 1
Data from steady - state polarization experiments

| | | Current density (A m⁻²) (Steady state Polarization) | | | | | | | | | |
|---|---|---|---|---|---|---|---|---|---|---|---|
| | | Air-saturated borate bath | | | | | Oxygenated borate bath | | | | |
| Electrode | Rotation | | | Enhancement | | Enhancement | | | Enhancement | | Enhancement |
| Cathode | rate (rpm) | 0.0 T | 0.4 T | (%) | 1.0 T | (%) | 0.0 T | 0.4 T | (%) | 1.0 T | (%) |
| A | 0 | 1.2 | 2.0 | 66.0 | 2.2 | 83.0 | 6.0 | 10.0 | 66.0 | 13.0 | 116.0 |
| | 500 | 5.3 | 8.5 | 60.0 | 9.0 | 69.0 | 17.0 | 28.0 | 65.0 | 38.0 | 124.0 |
| | 1000 | 7.1 | 11.0 | 55.0 | 12.5 | 76.0 | 23.0 | 39.0 | 70.0 | 50.0 | 117.0 |
| | 2000 | 9.6 | 14.0 | 46.0 | 18.0 | 87.0 | 31.0 | 55.0 | 72.0 | 65.0 | 111.0 |
| | 3000 | 11.0 | 17.0 | 54.0 | 22.0 | 100.0 | 36.0 | 68.0 | 90.0 | 80.0 | 122.0 |
| | | | | (69) | | (83) | | | (74) | | (118) |
| B | 0 | 0.75 | 0.8 | 7.0 | 1.1 | 46.0 | 1.0 | 1.15 | 15.0 | 1.3 | 30.0 |
| | 500 | 3.0 | 3.5 | 17.0 | 4.2 | 40.0 | 4.0 | 4.5 | 13.0 | 4.8 | 20.0 |
| | 1000 | 4.5 | 5.1 | 14.0 | 5.8 | 29.0 | 5.0 | 6.5 | 30.0 | 7.1 | 42.0 |
| | 2000 | 6.0 | 7.0 | 17.0 | 7.7 | 28.0 | 8.0 | 9.7 | 22.0 | 9.7 | 22.0 |
| | 3000 | 7.0 | 8.35 | 18.0 | 9.2 | 31.0 | 10.0 | 11.7 | 18.0 | 12.5 | 25.0 |
| | | | | (17) | | (32) | | | (21) | | (27) |
| C | 0 | 0.3 | 0.35 | 16.0 | 0.35 | 16.0 | 1.0 | 1.2 | 20.0 | 1.3 | 30.0 |
| | 500 | 1.3 | 1.5 | 15.0 | 1.6 | 23.0 | 4.4 | 4.8 | 9.0 | 4.7 | 9.0 |
| | 1000 | 2.1 | 2.2 | 5.0 | 2.3 | 9.5 | 6.5 | 6.8 | 5.0 | 7.0 | 8.0 |
| | 2000 | 2.9 | 3.0 | 3.0 | 3.2 | 10.0 | 8.4 | 8.8 | 5.0 | 9.0 | 7.0 |
| | 3000 | 3.5 | 3.7 | 6.0 | 3.95 | 10.0 | 9.0 | 9.5 | 6.0 | 10.5 | 17.0 |
| | | | | (7) | | (14) | | | (6) | | (10) |

TABLE 2
Data from chronoamperometry experiments

| | | Current density (A m⁻²) (Chronoamperometry) | | | | | | | | | |
|---|---|---|---|---|---|---|---|---|---|---|---|
| Electrode | Rotation | Air-saturated borate bath | | | | | Oxygenated borate bath | | | | |
| Cathode | rate (rpm) | 0.0 T | 0.4 T | Enhancement | 1.0 T | Enhancement | 0.0 T | 0.4 T | Enhancement | 1.0 T | Enhancement |
| A | 0 | 1.2 | 1.7 | 41.0 | 6.0 | 330.0 | 4.0 | 20.0 | 400.0 | 27.0 | 575.0 |
| | 500 | 5.2 | 7.5 | 44.0 | 12.0 | 130.0 | 12.5 | 40.0 | 220.0 | 50.0 | 300.0 |
| | 1000 | 7.5 | 10.0 | 34.0 | 16.0 | 113.0 | 17.0 | 50.0 | 194.0 | 70.0 | 310.0 |
| | 2000 | 9.0 | 14.0 | 55.0 | 22.0 | 144.0 | 22.0 | 62.0 | 180.0 | 87.0 | 295.0 |
| | 3000 | 11.0 | 17.0 | 55.0 | 27.0 | 145.0 | 26.0 | 68.0 | 160.0 | 100.0 | 284.0 |
| | | | | (47) | | (135) | | | (189) | | (297) |
| B | 0 | 2.4 | 3.3 | 37.0 | 3.4 | 41.0 | 2.6 | 3.7 | 26.0 | 3.0 | 16.0 |
| | 500 | 4.0 | 5.0 | 25.0 | 5.0 | 25.0 | 4.8 | 5.5 | 15.0 | 5.8 | 21.0 |
| | 1000 | 4.5 | 5.5 | 22.0 | 5.6 | 24.0 | 6.0 | 7.5 | 25.0 | 8.0 | 33.0 |
| | 2000 | 5.6 | 6.8 | 21.0 | 6.9 | 23.0 | 7.6 | 11.0 | 44.0 | 11.8 | 55.0 |
| | 3000 | 6.1 | 7.3 | 20.0 | 7.5 | 23.0 | 8.7 | 12.0 | 38.0 | 13.0 | 50.0 |
| | | | | (22) | | (24) | | | (31) | | (40) |
| C | 0 | 0.2 | 0.2 | 0.0 | 0.2 | 0.0 | 1.5 | 1.7 | 13.0 | 1.8 | 20.0 |
| | 500 | 1.2 | 1.5 | 7.0 | 1.6 | 14.0 | 5.0 | 5.2 | 4.0 | 5.2 | 4.0 |
| | 1000 | 2.2 | 2.3 | 5.0 | 2.3 | 5.0 | 6.7 | 7.0 | 5.0 | 7.5 | 12.0 |
| | 2000 | 2.8 | 3.1 | 10.0 | 3.1 | 10.0 | 8.7 | 9.0 | 4.0 | 9.5 | 10.0 |
| | 3000 | 3.6 | 3.7 | 3.0 | 3.8 | 5.0 | 11.0 | 11.5 | 4.0 | 11.5 | 5.0 |
| | | | | (6) | | (9) | | | (4) | | (8) |

More properly, to exclude all influence of the cobalt nanowires in the reference, we should use electrode ‘C’ as the control, and define current enhancement as

[j_{A}(B)−j_{C}(0)]/j_{C}(0) (8)

because the cobalt wires may have a remnant magnetization in zero field, and so exert a field gradient in the absence of an applied field. When Eq. (8) is used, the average current enhancement for the rotating electrode is 630% for the air-saturated and 820% for the oxygen saturated buffer. Even larger enhancements are found for the stationary electrode, but there the currents j_{C}(0) are small and the errors are proportionately greater.

The contrast between the effects reported here, and the enhancement of mass-transport-limited current due to the Lorentz force must be emphasized. The magnetohydrodynamic effect driven by the Lorentz force is equivalent to gentle stirring, and it makes a negligible addition to the limiting current when a rapidly-rotating electrode is used. Here a large enhancement factor is observed when the field gradient electrode ‘A’ is compared with its nonmagnetic counterpart ‘C’ (FIG. 9) regardless of rotation rate. Both electrodes present a chemically identical platinum working surface. The difference is the cobalt nanowire array in electrode ‘A’ which does not enter into contact with the electrolyte, but it creates a magnetic field gradient at the Pt surface where the electrochemical reduction reaction occurs. The current enhancement produced by rotating the electrode is due to improved mass transport, which is an effect that is different from, and independent of that produced by the magnetic field.

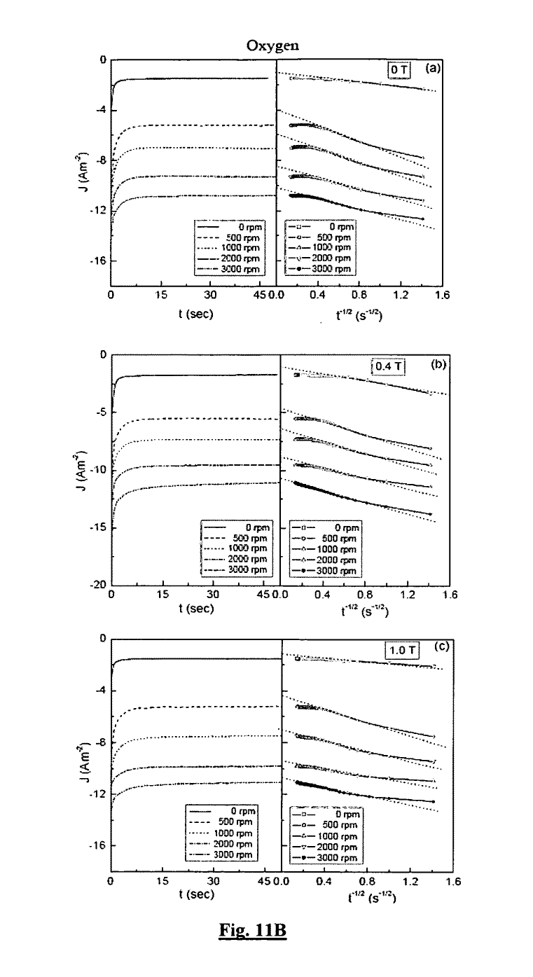

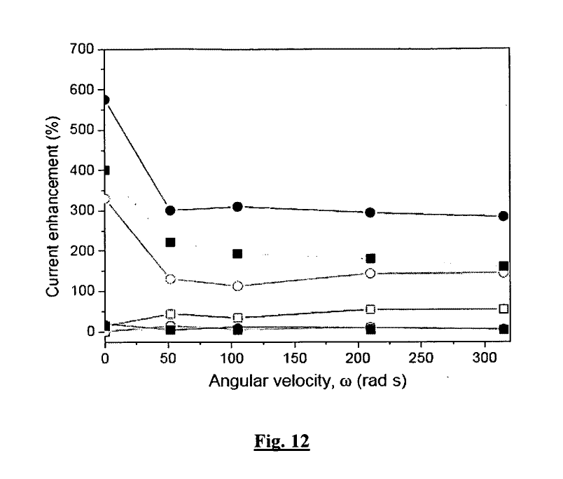

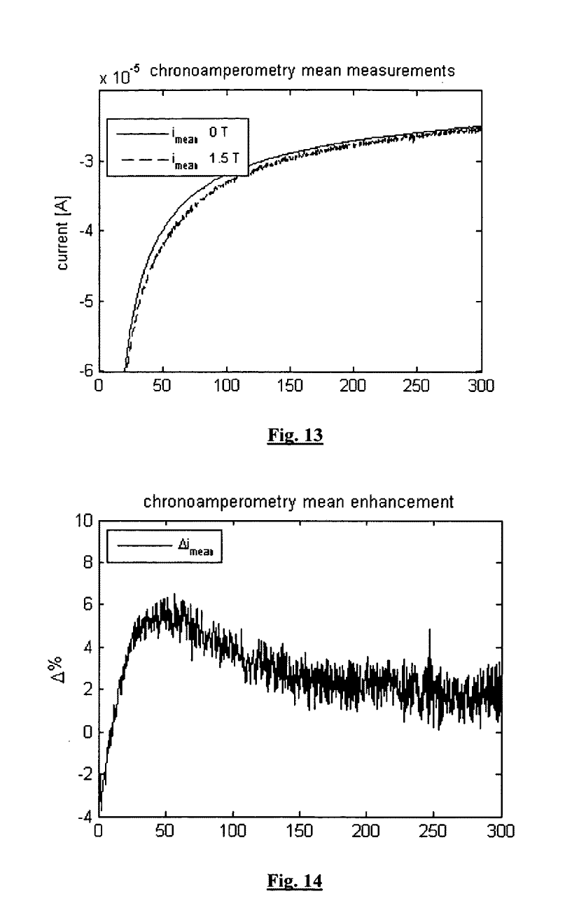

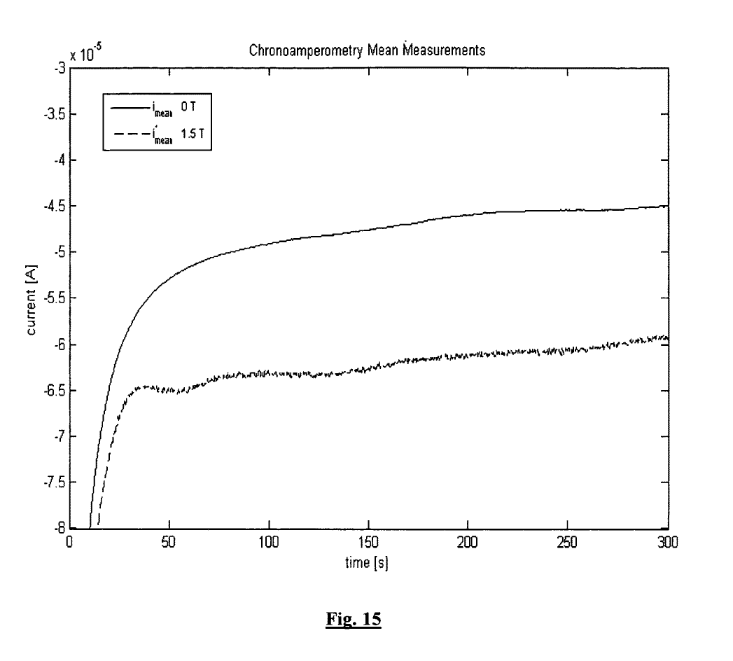

In contrast to the alkaline bath, only rotation-less chronoamperometry was performed using the acidic bath. Disc electrodes with an area of 132 mm² were used and the magnetic field was applied parallel to the nanowires. For electrode ‘C’ (FIGS. 13,14) there is no effect of the magnetic field on the oxygen reduction. Whereas for electrode ‘A’ a 30% enhancement in the current is observed under an applied field of 1.5 T (FIGS. 15 and 16). This further demonstrates that the field gradient electrode is applicable for both alkaline fuel cells and proton exchange membrane fuel cells.

It is important to distinguish the magnitude of the magnetic field B acting at the platinum surface from the magnetic field gradient V̅B. In our experiments, B is approximately the uniform applied field created by the electromagnet. This field, which creates a magnetohydrodynamic flow, has practically no effect when it acts alone, as the data for electrode ‘C’ in tables 2 and 3 show. The effect of the magnetic field gradient produced by a nanostructured ferromagnetic metal which used a permanently magnetized CoPt nanowire array [33]. The gradient there was large, V̅B≈10⁵ T m⁻¹, but the field created at the surface of the Pt overlayer was just 25 mT. As a result, the enhancement of the oxygen reduction reaction in the borate buffer was only 14%. This is similar to that found here for electrode ‘A’ in zero applied field. The cobalt nanowires have some remnant magnetisation, and will create a magnetic field pattern similar to that produced by the permanently-magnetised CoPt nanowires.

We deduce from the results that a large enhancement of the oxygen reduction reaction requires both a large field and a large field gradient. This is precisely as expected from the field gradient force which depends on V̅B²=2B V̅B. For the present electrodes, we estimate B V̅B to be greater than 10⁵ T² m⁻¹ at the platinum surface. Our estimate is based on the applied field, and scaling by the saturation magnetization the value of V̅B obtained by numerical simulation for a similar membrane filled with CoPt. The effect of the combination of field and field gradient is to attract and hold any paramagnetic species or free radical in the vicinity of the electrode surface. Diamagnetic species are repelled.

We suggested previously [33] that the magnetically-active species is HO₂⁻, which has S=1/2. The molar paramagnetic susceptibility according to the Curie law is

χₘ=Cₘ/T (9)

where Cₘ=1.57 10⁻⁶ p_{eff}², with p²_{eff}=3 for a species with S=1/2 and p²_{eff}=8 for a species such as O₂ with S=1. Hence at T=300 K, χₘ is approximately 2-4×10⁻⁸ mol⁻¹. The force F _{V̅B=χ}ₘ c B V̅B/μ₀ depends on the concentration c of the paramagnetic species in the electrolyte. If we assume a 0.01 M concentration, c=1 mol m⁻³ of a species with S=½, the force density F _{V̅} is in excess of 10⁴ N m⁻³. This is large compared with other forces acting on electrolytes, although it is four orders of magnitude less than the force thermodynamic force driving diffusion RT V̅c, which is estimated from the limiting currents to be ˜2 10⁸ N m⁻³.

The magnetic gradient force of Eq 2 cannot be expected to exert any appreciable effect on diffusive processes. However, it is effective at restricting dispersive effects due to convection. The explanation of the effectiveness of the magnetic field gradient may therefore be that it stabilizes the concentration of electroactive species near the electrode surface against the effects of convective dispersion, but not diffusion.

The field gradient force will be only appreciable within a few hundred nanometers of the electrode surface, since the fluctuations in stray field from the cobalt fall off on the length scale of the nanowire separation. It is the near-electrode concentration gradient that is protected from the effects of dispersion, and this is not influenced by rotation of the electrode.

In the invention, the considerable enhancement of the model oxygen reduction reaction is due to the magnetic field gradient force, which depends on the product of magnetic field and magnetic gradient. A large field gradient is achieved by using a nanostructured ferromagnet backing the platinum working electrode, and the effectiveness is greatly increased by applying a large external magnetic field.

Reaction rates for other electrochemical processes involving paramagnetic molecules, ions or free radicals can be similarly enhanced by using appropriately-designed electrodes that create a magnetic field gradient. In particular, the invention may be applied to the reaction at the oxygen electrode in fuel cells. Any increase in the catalytic oxygen reduction current effectively increases power density. This has the added benefit of reducing the device size while retaining the same power as generated by a fuel cell without a field gradient electrode. The large magnetic field gradient force is repulsive to diamagnetic CO, this can decrease the CO poisoning of Pt electrodes, allowing the fuel cell to tolerate higher concentrations of CO in the O2 flow, and increase the durability of the Pt electrodes. In solutions similar to that used in the acidic bath, Pt dissolution was readily observed by cycling the potential from around −1 V versus Ag/AgCl to 0 V versus Ag/AgCl [37]. Active dissolution occurred at ˜0 V versus Ag/AgCl so any potential shift away from Pt dissolution due to the magnetic field gradient is desirable.

The length scale over which the magnetic force is exerted can be controlled via the spacing in the structured array of magnetic material.

There is no need to disturb the fluid with foreign bodies other than the surface where the magnetic field gradient is generated.

There is an ability to control the magnitude of the magnetic force by making the primary magnet a variable field permanent magnet or electromagnet

The invention may be used to enhance or modify the rate of electrochemical reactions involving free radicals or paramagnetic species. Important examples are the oxygen electrode reactions in fuel cells and for water electrolysis.

The invention is therefore is especially suitable for medical and energy applications.

The invention is not limited to the embodiment hereinbefore described, which may be varied in construction and detail.

### REFERENCES

[1] T. Z. Fahidy, J. Appl. Electrochem. 13 (1983) 553.
[2] R. A. Tacken, L. J. J. Janssen, J. Appl. Electrochem. 25 (1995) 1.
[3] Magnetic Field Effects in Electrochemistry, Special Issue of J. Solid State Electrochemistry 11 (2007) A Bund (editor)
[4] T. Z. Fahidy, Electrochim. Acta 18 (1973) 607.
[5] G. Hinds, F. E. Spada, J. M. D. Coey, T. R. Ni Mhiochain, M. E. G. Lyons, J. Phys. Chem. B. 105 (2001) 9487.
[6] J. Kosa, M. Uhlemann, A. Gebert and L. Schultz, J. Solid State Electrochem. 12 181 (2008)
[7] I. Mogi, M. Kamiko, J. Cryst. Growth 166 (1996) 276.
[8] T. Z. Fahidy, Progress Surface Sci. 68 (2001) 155.
[9] T. R. Ni Mhiochain, G. Hinds, A. Martin, Z. Y. E. Chang, A. Lai, L. Costiner, J. M. D. Coey, Electrochim. Acta 49 (2004) 4813.
[10] M. Waskaas, Y. I. Kharkats, J. Phys. Chem. B 103 (1999) 4876.
[11] F. M. F. Rhen, G. Hinds, J. M. D. Coey, Electrochem. Comm. 6 (2004) 413.
[12] A. Dass, J. A. Counsil, X. Gao, N. Leventis, J. Phys. Chem. B 109 (2005) 11065.
[13] Z. Lu, D. Huang, W. Yang, Corrosion Sci. 47 (2005) 1471.
[14] K. Shinohara, R. Aogaki, Electrochem. 67 (1999) 126.
[15] T. Sasada, A. Sato, Phys. Lett. A 266 (2000) 350.
[16] F. M. F. Rhen, J. M. D. Coey, J. Phys. Chem. B, 110 (2006) 6274.
[17] M. Uhlemann, A. Krause, A. Gebert, J. Electoanal. Chem. 577 (2005) 19.
[18] S. R. Ragsdale, J. Lee, X. Gao, H. S. White, J. Phys. Chem. 100 (1996) 5913.
[19] O. Aaboubi, P. Los, J. Amblard, J.-P. Chopart, A. Olivier, J. Electrochem. Soc. 150 (2003) E125.
[20] T. Weier, K. Eckert, S. Muehlenhoff, C. Cierpka, A. Bund and M. Uhlemann, Electrochem. Commun. 9 2479 (2007)
[21] K. Shinohara, K. Hashimoto and R. Aogaki, Electrochemistry 70 (2002) 772.
[22] S. R. Ragsdale, K. M. Grant, H. S. White, J. Am. Chem. Soc. 120 (1998) 13461.
[23] M. D. Pullins, K. M. Grant, H. S. White, J. Phys. Chem. B 105 (2001) 8989.
[24] S. Kishioka, A. Yamada, R. Aogaki, Electroanalysis 13 (2001) 1-3 1161.
[25] T. Okada, N. T. Wakayama, L. Wang, H. Shingu, J. Okano, T. Ozawa, Electrochim. Acta 48 (2003) 531.
[26] N. I. Wakayama, T. Okada, J. Okano, T. Ozawa, Japan J. Appl. Phys 40 (2001) L269.
[27] J. M. D. Coey, F. M. F. Rhen, P. Dunne and S. McMurray, J. Solid State Electrochem., 11 711 (2007).
[28] L. Landau and E. M. Lifschitz (1984) Electrodynamics of Continuous Media, §35. Pergammon, Oxford.
[29] C. M. A. Brett and A. M. O. Brett, Electrochemistry: Principles, Methods, and Applications, Oxford University Press, p. 349 (1993).
[30] J. M. Andujar, F. Segura, Renewable and Sustainable Energy Reviews 13 2309-2322 (2009).
[31] F. A. de Bruijn, et al., Fuel Cells 8 3-22 (2008).
[32] V. Mehta, J. S. Cooper, J. Power Sources 114 32-53 (2003).
[33] N. B. Chaure, M. F. M. Rhen, J. Hilton and J. M. D. Coey, Electrochem Comm. 9 155 (2007)
[34] N B Chaure, P Stamenov, F M F Rhen and J M D Coey, J. Magn. Magn. Mater., 290 (2005) 1210.
[35] Y Miyata and S Asakura, Corrosion Sci. 44 (2002) 589
[36] P. Lorbeer, W. J. Lorenz, Electrochim. Acta, 25 (1980) 375.
[37] M. Umeda, et al., J. Phys. Chem. C 113 15707-15713 (2009).

1. An electrochemical device comprising:—
a primary magnet and a secondary magnet for applying forces to magnetic entities of an electrolyte, the primary magnet being arranged to induce a magnetic moment in the magnetic entities; and
the secondary magnet being arranged to create a magnetic field gradient in the vicinity of the magnetic entities to control the magnetic entities.

2. The device as claimed in claim 1 wherein the product of the field B (in Tesla) and the field gradient V̅B (Tesla per metre) is from 10² to 10⁸ T²/m.

3. The device as claimed in claim 2 wherein V̅B² is from 10⁴ to 10⁶ T²/m.

4. The device as claimed in claim 3 wherein V̅B² is approximately 10⁵ T²/m.

5. The device as claimed in claim 1 wherein the secondary magnet is incorporated in an electrode of the electrochemical device.

6. The device as claimed in claim 5 wherein the electrode comprises a ferromagnetic material.

7. The device as claimed in claim 6 wherein the electrode comprises a nanowire array.

8. The device as claimed in claim 7 wherein the diameter of the nanowires in the nanowire array is in the range of from 10 nm to 10 μm.

9. The device as claimed in claim 8 wherein the diameter of the nanowires is from 10 nm to 1 μm.

10. The device as claimed in claim 9 wherein the diameter of the nanowires is approximately 100 nm.

11. The device as claimed in claim 7 wherein the nanowire array comprises a porous template having a partial coating of an electrode material and a partial filling of a ferromagnetic material.

12. The device as claimed in claim 11 wherein the porous template comprises alumina.

13. The device as claimed in claim 11 wherein the electrode material is platinum.

14. The device as claimed in claim 6 wherein the ferromagnetic material comprises cobalt or a ferromagnetic alloy based on cobalt or iron.

15. The device as claimed in claim 1 wherein the primary magnet is an electromagnet.

16. The device as claimed in claim 1 wherein the primary magnet is a permanent magnet structure external or internal to the electrochemical cell.

17. The device as claimed in claim 1 wherein the primary magnet comprises an arrangement of permanent magnet segments.

18. The device as claimed in claim 1 wherein the electrode is movable.

19. The device as claimed in claim 18 wherein the electrode is rotatable.

20. The energy storage system comprising an electrochemical device as claimed in claim 1.

21. The fuel cell comprising an electrochemical device as claimed in claim 1.

22. The fuel cell stack comprising a plurality of fuel cells as claimed in claim 21.

23. The alkaline fuel cell comprising an electrochemical device as claimed in claim 1.

24. The proton exchange membrane fuel cell comprising an electrochemical device as claimed in claim 1.
